(19) United States
(12) Patent Application Publication
(10) Pub. No.: US 2012/0084730 A1
(43) Pub. Date: Apr. 5, 2012

(54) ELECTRONIC APPARATUS, ICON DISPLAY METHOD, AND PROGRAM FOR ELECTRONIC APPARATUS

(75) Inventors: Tatsuyoshi NOMA, Nakano-ku (JP); Hiroshi YAMAZAKI, Oume-shi (JP)

(73) Assignee: KABUSHIKI KAISHA TOSHIBA, Tokyo (JP)

(21) Appl. No.: 13/229,420

(22) Filed: Sep. 9, 2011

(30) Foreign Application Priority Data
Sep. 30, 2010 (JP) 2010-223192

(51) Int. Cl. G06F 3/048

(52) U.S. Cl. 715/830

(57) ABSTRACT

According to one embodiment, there is provided an electronic apparatus, including: a display screen on which icons are displayed; a first icon display area within the display screen, the first icon display area displaying plural icons having approximately the same size so as to be arranged approximately in a one-dimensional direction while avoiding an overlap between the icons; and a second icon display area continuous with the first icon display area in the one-dimensional direction within the display screen, the second icon display area displaying plural icons so as to be decreased in size as it goes away from the first icon display area while allowing an overlap between the icons.

### CROSS-REFERENCE TO RELATED APPLICATION(S)

This application is based upon and claims the benefit of priority from Japanese Patent Application No. 2010-223192, filed on Sep. 30, 2010, the entire contents of which are incorporated herein by reference.

### FIELD

Embodiments described herein relate generally to an electronic apparatus which displays plural icons on the display screen.

### BACKGROUND

In recent years, electronic apparatus which display plural icons on the display screen have spread. While manipulating an electronic apparatus using icons is convenient, if an unduly large number of icons are displayed on the display screen, the user would have difficulty finding a desired icon and feel cumbersome.

### BRIEF DESCRIPTION OF DRAWINGS

A general architecture that implements the various feature of the present invention will now be described with reference to the drawings. The drawings and the associated descriptions are provided to illustrate embodiments and not to limit the scope of the present invention.

FIG. 1 illustrates an appearance of an electronic apparatus according to an embodiment.

FIG. 2 illustrates the system configuration of the electronic apparatus according to the embodiment.

FIG. 3 is a front view of the display screen of the electronic apparatus according to the embodiment on which example icons are displayed.

FIGS. 4A and 4B illustrate how icons are scrolled in the electronic apparatus according to the embodiment.

FIG. 5 imaginarily illustrates icons displayed or not displayed on the display screen in an initial state, as viewed obliquely from above.

FIG. 6 imaginarily illustrates icons displayed or not displayed on the display screen (scrolling has been performed from the state of FIG. 5), as viewed obliquely from above.

FIG. 7 illustrates an icon selection process executed by the electronic apparatus according to the embodiment.

FIG. 8 imaginarily illustrates icons displayed or not displayed on the display screen in an initial state in an electronic apparatus according to another embodiment, as viewed obliquely from above.

### DETAILED DESCRIPTION

In general, according to one embodiment, there is provided an electronic apparatus, including: a display screen on which icons are displayed; a first icon display area within the display screen, the first icon display area displaying plural icons having approximately the same size so as to be arranged approximately in a one-dimensional direction while avoiding an overlap between the icons; and a second icon display area continuous with the first icon display area in the one-dimensional direction within the display screen, the second icon display area displaying plural icons so as to be decreased in size as it goes away from the first icon display area while allowing an overlap between the icons.

An embodiment will be hereinafter described with reference to the drawings.

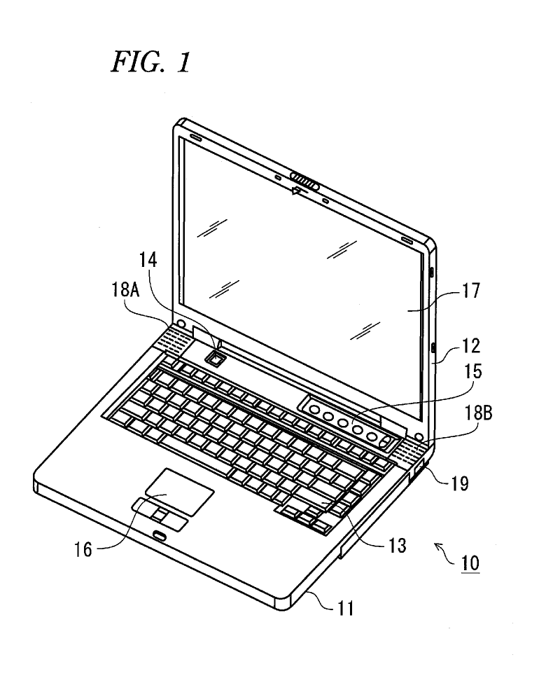

FIG. 1 illustrates an appearance of a notebook personal computer 10 as an electronic apparatus according to the embodiment.

The embodiment may be applied to TV receivers, cell phones, and portable electronic apparatus, instead of personal computers.

As shown in FIG. 1, the computer 10 is composed of a computer main body 11 and a display unit 12. The display unit incorporates an LCD (liquid crystal display) 17. The display unit 12 is attached to the computer main body 11 so as to be rotatable between an open position where it exposes the top surface of the computer main body 11 and a closed position where it covers the top surface of the computer main body 11.

The computer main body cabinet 11 has a thin box-shaped cabinet, and its top surface is provided with a keyboard 13, a power button 14 for powering on and off the computer 10, an input manipulation panel 15, a touch pad 16, speakers 18A and 18B, etc. Various manipulation buttons are provided on the manipulation panel 15.

The right-hand surface of the computer main body cabinet 11 is provided with a USB connector 19 to which a USB cable or a USB device that complies with the USB (universal serial bus) 2.0 standard is to be connected.

The back surface of the computer main body cabinet 11 is provided with an external display connection terminal (not shown) that complies with the HDMI (high-definition multimedia interface) standard, for example. The external display connection terminal is used for outputting a digital video signal to an external display.

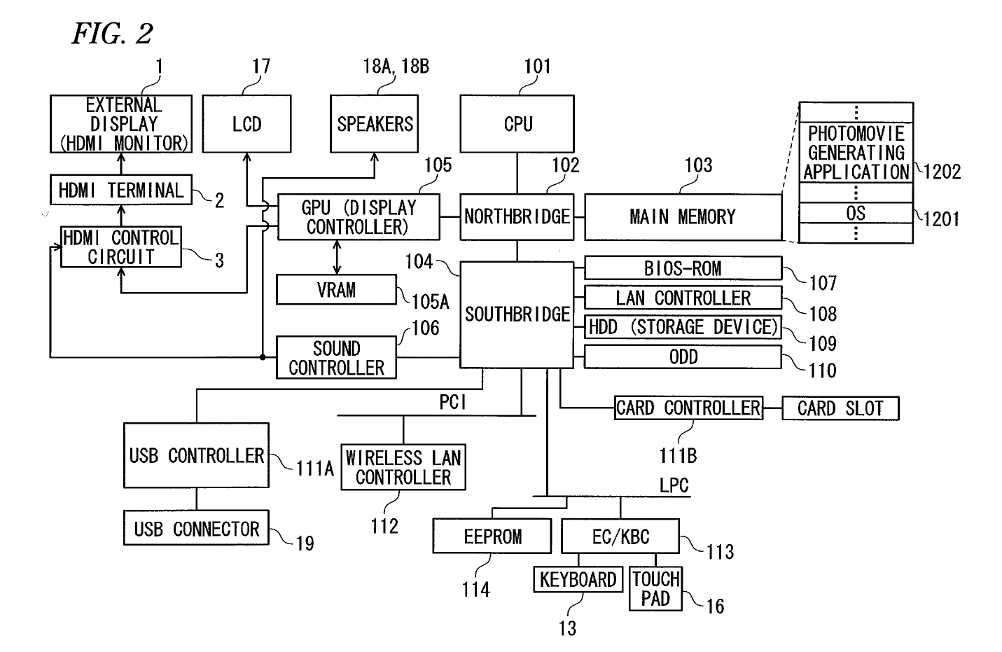

FIG. 2 illustrates the system configuration of the computer 10. As shown in FIG. 2, the computer 10 is equipped with a CPU (central processing unit) 101, a northbridge 102, a main memory 103, a southbridge 104, a GPU (graphics processing unit) 105, a VRAM (video random access memory) 105A, a sound controller 106, a BIOS-ROM (basic input/output system-read only memory) 107, a LAN (local area network) controller 108, a hard disk drive (HDD) 109, an optical disc drive (ODD) 110, a USB controller 111A, a card controller 111B, a wireless LAN controller 112, an embedded controller/keyboard controller (EC/KBC) 113, an EEPROM (electrically erasable programmable ROM) 114, etc.

The CPU 101 is a processor which controls operations of individual components of the computer 10. The CPU 40 runs an operating system (OS) 201 and various application programs such as a photomovie generating application program 202.

The photomovie generating application program 202 is software for reproducing various digital contents stored in the HDD 109, for example. The photomovie generating application program 202 has a moving image generating function, which is a function of generating a moving image (photomovie, slide show, or the like) using materials (digital contents) such as photographs stored in the HDD 109, for example.

The photomovie generating application program 202 also has a function of analyzing materials to be used for generating a moving image. The photomovie generating application program 202 reproduces a moving image that has been generated by using materials, and displays it on the screen (LCD 17).

The CPU 101 also runs a BIOS which is stored in the BIOS-ROM 107. The BIOS is programs for hardware control.

The northbridge 102 is a bridge device for connecting a local bus of the CPU 101 to the southbridge 104. The northbridge 102 incorporates a memory controller for access-controlling the main memory 103. The northbridge 11 also has a function of performing a communication with the GPU 105 via, for example, a serial bus that complies with the PCI Express standard.

The GPU 105 is a display controller which controls the LCD 17 which is used as a display monitor of the computer 10.

A display signal generated by the GPU 105 is sent to the LCD 17. The GPU 105 can send a digital video signal to an external display 1 via an HDMI control circuit 3 and an HDMI terminal 2.

The HDMI terminal 2 is the above-mentioned external display connection terminal. The HDMI terminal 2 can send a non-compressed digital video signal and digital audio signal to the external display 1 such as a TV receiver via a single cable. The HDMI control circuit 3 is an interface for sending a digital video signal to the external display 1 (called an HDMI monitor) via the HDMI terminal 2.

The southbridge 104 controls the individual devices on a PCI (peripheral component interconnect) bus and the individual devices on an LPC (low pin count) bus. The southbridge 104 incorporates an IDE (integrated drive electronics) controller for controlling the HDD 109 and the ODD 110.

The southbridge 104 also has a function of controlling a communication with the sound controller 106.

The sound controller 106, which is a sound source device, outputs reproduction subject audio data to the speakers 18A and 18B or the HDMI control circuit 3. The LAN controller 108 is a wired communication device which performs a wired communication according to the IEEE 802.3 standard, for example. On the other hand, the wireless LAN controller 112 is a wireless communication device which performs a wireless communication according to the IEEE 802.11g standard, for example. The USB controller 111A performs a communication with an external device that is connected to the USB connector 19 and complies with the USB 2.0 standard, for example.

For example, the USB controller 111A is used for receiving an image data file from a digital camera. The card controller 111B writes and reads data to and from a memory card such as an SD card that is inserted in a card slot that is formed in the computer main body 11.

The EC/KBC 113 is a one-chip microcomputer in which an embedded controller for power management and a keyboard controller for controlling the keyboard 13 and the touch pad 16 are integrated together. The EC/KBC 113 has a function of powering on or off the computer 10 in response to a user manipulation of the power button 14.

In the embodiment, display control is performed in such a manner that, for example, the CPU 101 runs a program stored in the main memory 103, the HDD 109, or the like.

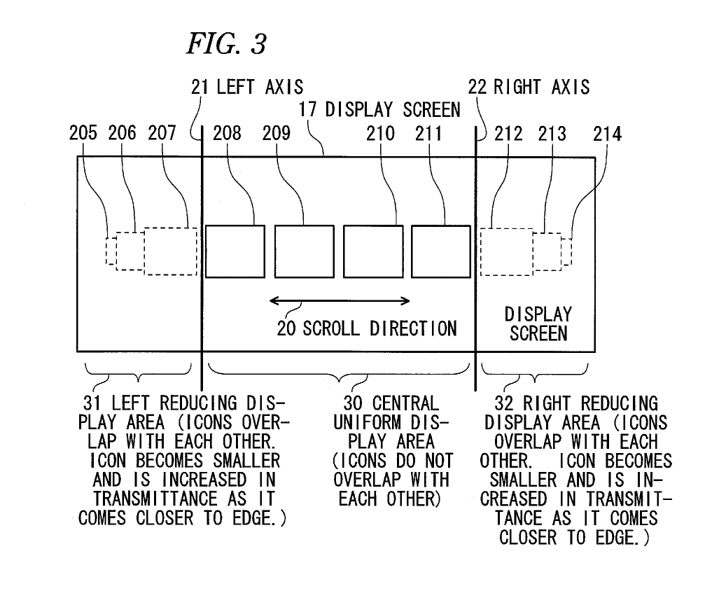

FIG. 3 is a front view of the display screen (of the LCD) 17 of the computer 10 on which example icons are displayed. In the embodiment, plural icons are displayed on the display screen 17 so as to be arranged in a one-dimensional direction (e.g., in the horizontal direction). For example, plural icons 208-211 having approximately the same size are displayed in a central uniform display area 30 of the display screen 17 approximately at the same intervals (so as not to overlap with each other). The plural icons may be arranged in the vertical direction or in the oblique direction. Alternatively, the plural icons may be arranged in a two-dimensional direction (e.g., in the L-shape along two sides of the display screen, in the angular-U-shape along three sides of the display screen, or in the angular-O-shape along four sides of the display screen), or may be arranged in two lines.

For example, the icons 208-211 are displayed in the central uniform display area 30 with a size that is 100% of a standard size (equimagnification) at a transmittance 0% (opaque). One of the icons 208-211 can be selected according to a user instruction.

On the other hand, in each of display areas (a left reducing display area 31 and a right reducing display area 32) located on both sides of the central uniform display area 30, the size of the displayed icon is reduced gradually (decreased in size gradually) as it goes away from the central uniform display area 30.

In each of the left reducing display area 31 and the right reducing display area 32, the icon display interval is decreased and adjoining icons overlap with each other. Furthermore, the transmittance (transparency) of the icon is increased as it goes away from the central uniform display area 30.

For example, in the left reducing display area 31, icons 207, 206, and 205 are displayed so as to be smaller than the icon 208. More specifically, the icons 207, 206, and 205 are displayed so as to be decreased in size and increased in transmittance as the position goes away from the central uniform display area 30 and so that adjoining icons overlap with each other.

An imaginary left axis 21 (not displayed in an actual product) is set between the central uniform display area 30 and the left reducing display area 31. Likewise, an imaginary right axis 22 is set between the central uniform display area 30 and the right reducing display area 32.

For example, a scroll manipulation is performed on the icons 205-214 by the user. For example, a scroll manipulation is performed in such a manner that the user manipulates a touch screen (not shown) attached to the display screen 17 or a mouse, a ten-key unit, or the like that is used with or provided in the personal computer 10.

When a scroll manipulation is performed on the icons 205-214, the icons 205-214 are moved on the display screen 17. When an icon crosses the left axis 21 or the right axis 22, the manner of display of the icon is changed as described above.

That is, in the embodiment, among plural icons that are arranged along a horizontal line, icons displayed in the central uniform display area 30 that is located between the left and right imaginary axes (left axis 21 and right axis 22) on the display screen 17 have approximately the same intervals and sizes and are substantially opaque.

Icons that are located outside each of the left and right imaginary axes (left axis 21 and right axis 22) are decreased in size and display interval and increased in transmittance (transparency) as the position comes closer to the edge of the display screen 17.

Adjoining icons whose interval is decreased are displayed so as to overlap with each other, whereby the icon appears as if to be located at a deeper position as it comes closer to the edge of the display screen 17.

When icons are scrolled, they are moved together while an icon that has reached the scroll destination end disappears and a new icon appears at the scroll source end.

The number of icons displayed on the display screen 17 is kept constant, and an icon disappears before it reaches the edge of the display screen 17.

One of the icons displayed on the display screen 17 can be selected according to a user instruction irrespective of its size. As for icons that are displayed near each edge of the display screen 17 so as to overlap with each other, an icon that is closest to the center is selected preferentially.

With the above measures, the visibility of the icons is increased and the user can select a target icon easily.

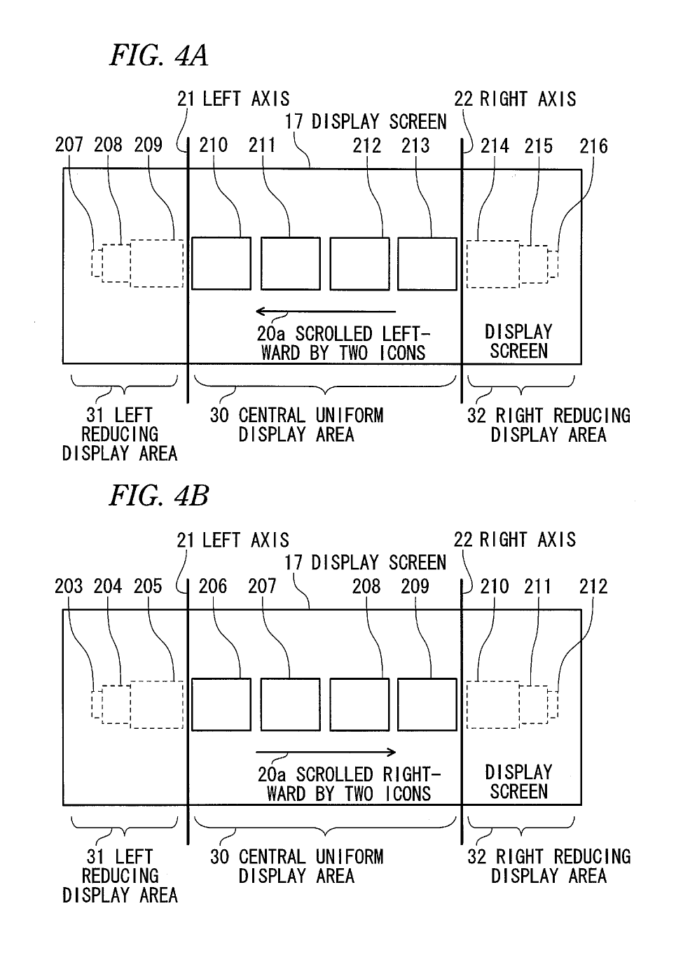

FIGS. 4A and 4B illustrate how icons are scrolled in the computer 10 according to the embodiment.

FIG. 4A shows an example display in which the icons have been scrolled leftward by two icons on the display screen from the state of FIG. 3. Since the icons have been scrolled leftward by two icons on the display screen 17, the icons 207-209 are displayed in the left reducing display area 31, the icons 210-213 are displayed in the central uniform display area 30, and icons 214-216 are displayed in the right reducing display area 32. The manner of display of each icon is as described above.

FIG. 4B shows an example display in which the icons have been scrolled rightward by two icons on the display screen 17 from the state of FIG. 3. Since the icons have been scrolled rightward by two icons on the display screen 17, icons 203-205 are displayed in the left reducing display area 31, the icons 206-209 are displayed in the central uniform display area 30, and the icons 210-212 are displayed in the right reducing display area 32. The manner of display of each icon is as described above.

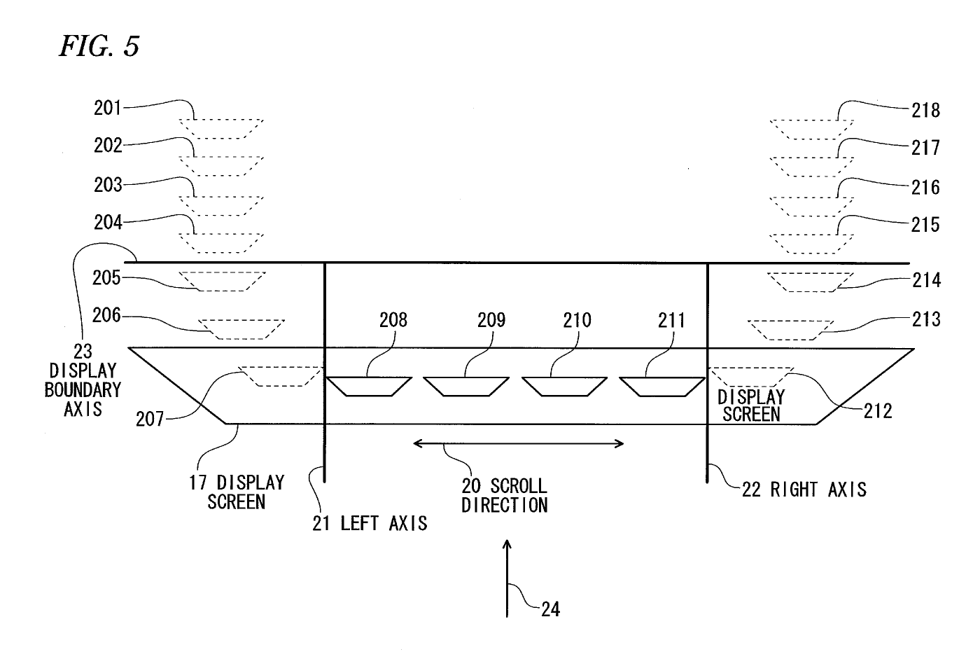

FIG. 5 imaginarily illustrates icons displayed or not displayed on the display screen 17 in an initial state in the computer 10 according to the embodiment, as viewed obliquely from above.

Among icons 201-218 shown in FIG. 5, only icons 205-214 that are located on the front side of a display boundary axis 23 are displayed on the display screen 17. Reference numeral 24 denotes a user viewing direction.

The icons 201-204 and 215-218 are not displayed on the display screen 17. The user cannot see and hence cannot select the icons 201-204 and 215-218.

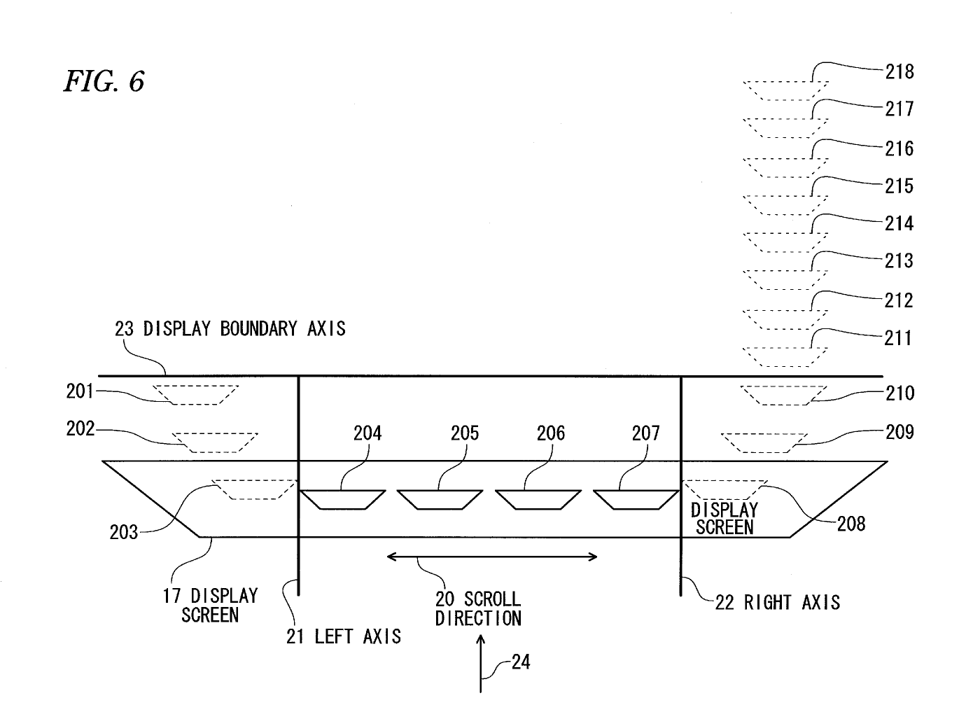

FIG. 6 also imaginarily illustrates icons displayed or not displayed on the display screen 17 (scrolling has been performed from the state of FIG. 5) in the computer 10 according to the embodiment, as viewed obliquely from above.

FIG. 6 shows a resulting state when the user has made an instruction to scroll the icons rightward by four icons from the state of FIG. 5. Whereas the icons 201-204 are newly placed on the front side of the display boundary axis 23 and hence are displayed, the icons 211-218 are not seen by the user and hence cannot be selected.

Since the icon 201 is the left end icon, the user cannot scroll the icons rightward further.

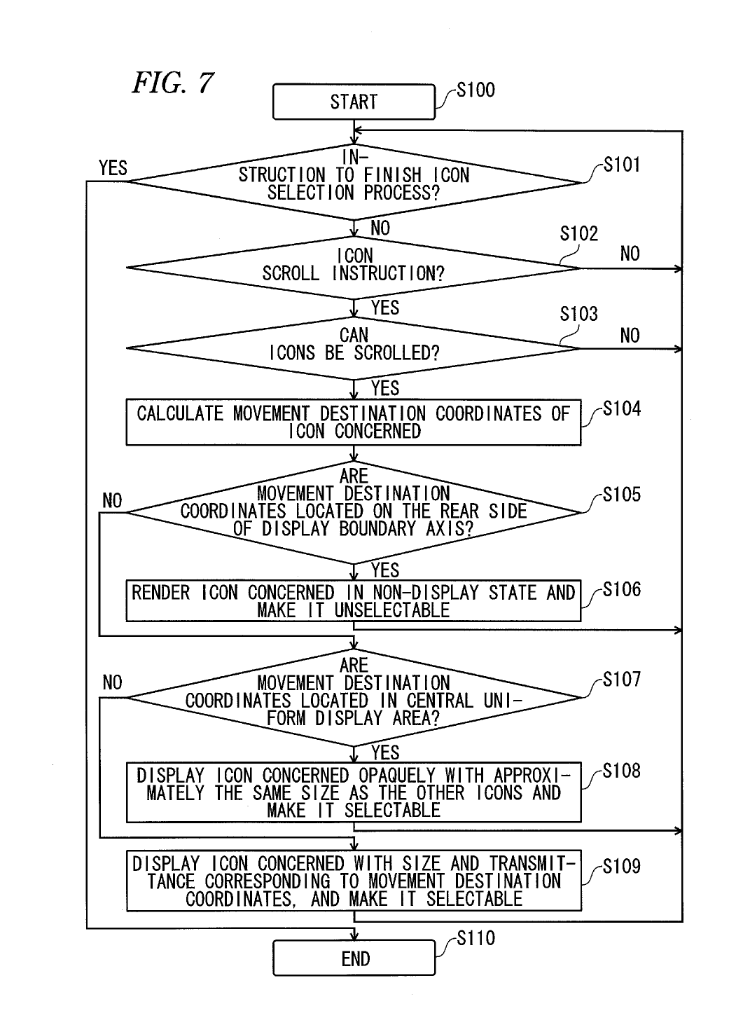

FIG. 7 illustrates an icon selection process executed by the computer 10 according to the embodiment. Although the process of FIG. 7 is directed to one icon, the same process is executed for each of the other icons.

The process is started at step S100. At step S101, it is judged whether an instruction to finish the icon selection process has been received or not. If the user instructs to finish the icon selection process (S101: yes), the process is finished at step S110.

If the user does not instruct to finish the icon selection process (S101: no), the process proceeds to step S102, where it is judged whether an instruction to scroll the icons has been received or not. This judgment is made by judging whether or not the user has moved the mouse cursor in a horizontal direction while continuing to click an icon using the mouse cursor or, if the computer 10 is equipped with a touch screen, the user has slid his or her finger in a horizontal direction while continuing to touch an icon with the finger.

If no icon scroll instruction has been received (S102: no), the process returns to step S101. If an icon scroll instruction has been received (S102: yes), the process proceeds to step S103, where it is judged whether the icons can be scrolled or not.

Since there exist the left end icon and the right end icon, the icons cannot be scrolled if it is attempted to scroll the icons rightward in the state of FIG. 6. In such a case, it is judged that the icons cannot be scrolled (S103: no) and the process returns to step S101. Likewise, if it is attempted to scroll the icons leftward in a state that the right end icon 218 is located on the front side of the display boundary axis 23 (S103: no), it is judged that the icons cannot be scrolled and the process returns to step S101.

In the other cases, it is judged that the icons can be scrolled (S103: yes), the process proceeds to step S104, where movement destination coordinates of an icon concerned are calculated. At step S105, it is judged whether or not the movement destination coordinates are on the rear side of the display boundary axis 23. If the movement destination coordinates are on the rear side of the display boundary axis (S105: yes), the process proceeds to step S106, where the icon concerned is rendered in a non-display state and hence is made unselectable by the user. Then, the process returns to step S101.

If the movement destination coordinates are on the front side of the display boundary axis 23 (S105: no), the process proceeds to step S107, where it is judged whether or not the movement destination coordinates are located in the central uniform display area 30. If the movement destination coordinates are located in the central uniform display area 30 (S107: yes), the process proceeds to step S108, where the icon concerned is equimagnification-displayed opaquely and made selectable by the user. Then, the process returns to step S101.

If the movement destination coordinates are not located in the central uniform display area 30 (S107: no), the process proceeds to step S109, where the icon concerned is displayed with a size that is calculated on the basis of a magnification corresponding to the movement destination coordinates at a position and a transmittance corresponding to the movement destination coordinates and is made selectable by the user. Then, the process returns to step S101.

The embodiment is particularly effective in a case that search items have a start and an end like telephone directory icons which represent data in alphabetical order.

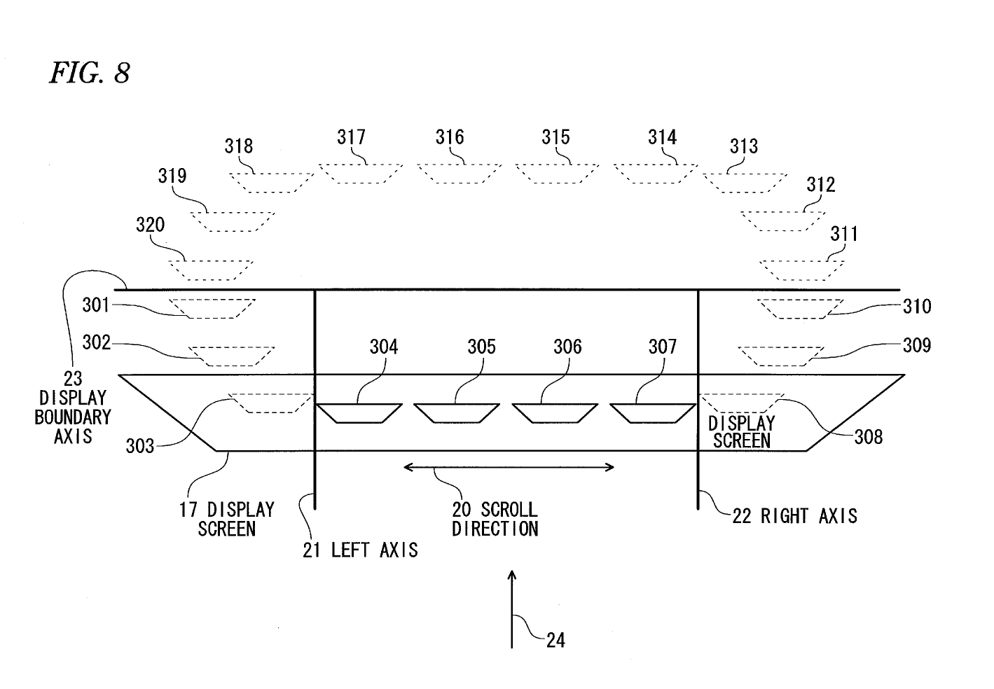

FIG. 8 imaginarily illustrates icons displayed or not displayed on the display screen 17 in an initial state in a computer according to another embodiment, as viewed obliquely from above.

In this embodiment, icons are arranged differently than in the above embodiment (see FIG. 5) in that icons located on the rear side of the display boundary axis 23 have neither a right end icon or a left end icon and are arranged in loop form. As a result, the user can scroll the icons leftward or rightward endlessly (i.e., the scroll is not stopped) and can continue to search for a target icon.

An icon selection process according to this embodiment is different from the process of FIG. 7 in that step S103 for judging whether the icons can be scrolled or not is omitted.

This embodiment is particularly effective in a case that the icon arrangement order is not important as in application icons or the number of icons is large.

A modification is possible in which the icons displayed in the central uniform display area 30 are not made opaque either. In this case, all displayed icons have a feel of transparency and are beautiful.

Another modification is possible in which icons are arranged and allowed to be scrolled in the vertical direction or a diagonal direction rather than in the horizontal direction.

As a further modification, icons may have any shape such as a circle or a polygon rather than a rectangle.

According to the embodiments, since the plural icons are equimagnification-displayed in the central uniform display area 30, the user can find a target icon easily by scrolling.

Since the icons in each of the side display areas 31 and 32 are displayed semi-transparently so as to overlap with each other, the visibility of all displayed icons is increased.

According to the embodiments, it is possible to solve the problem that if an unduly large number of icons are displayed on the display screen of an electronic apparatus the user would have difficulty finding a desired icon and feel cumbersome.

The invention is not limited to the above embodiments, and may be embodied while modifying constituent elements without departing from the scope of the invention.

1. An electronic apparatus, comprising:
a display screen configured to display icons;
a first icon display area within the display screen, the first icon display area comprising a first plurality of icons having approximately the same size, the first plurality of icons arranged approximately in a one-dimensional direction, the first plurality of icons not overlapping one another; and
a second icon display area continuous with the first icon display area in the one-dimensional direction within the display screen, the second icon display area displaying a second plurality of icons so as to be decreased in size in a direction away from the first icon display area, at least one of the second plurality of icons overlapping at least one other of the second plurality of icons.

2. The apparatus of claim 1,
wherein transmittance of each of the second plurality of icons increases, as each of the second plurality of icons is further from the first icon display area.

3. The apparatus of claim 1,
wherein, in the second icon display area, a first icon of the second plurality of icons is more distant from the first icon display area than a second icon of the second plurality of icons, the first icon displayed behind the second icon.

4. The apparatus of claim 1,
further comprising a third icon display area on a side of the first icon display area opposite the side continuous with the second icon display area.

5. The apparatus of claim 1,
wherein the apparatus is configured to perform a scrolling display in the one-dimensional direction on the icons displayed in the first icon display area and the icons displayed in the second icon display area.

6. The apparatus of claim 5,
wherein the apparatus is configured to enable each icon displayed in the first icon display area to move into the second icon display area to be displayed therein by the scrolling display.

7. The apparatus of claim 1,
wherein the icons of the first plurality of icons are larger than the icons of the second plurality of icons.

8. The apparatus of claim 1,
wherein at least three icons are displayed in the second icon display area.

9. The apparatus of claim 1,
wherein the first plurality of icons are displayed in the first icon display area substantially opaquely and the second plurality of icons are displayed in the second icon display area substantially transparently.

10. The apparatus of claim 1,
wherein the first plurality of icons displayed in the first icon display area and the second plurality of icons displayed in the second icon display area are selectable.

11. An icon display method, comprising:
displaying a first plurality of icons having approximately the same size within a display screen, to the first plurality of icons arranged approximately in a one-dimensional direction, the first plurality of icons not overlapping one another; and
displaying a second plurality of icons continuously with the first plurality of icons in the one-dimensional direction within the display screen, so as to be decreased in size in a direction away from the first icon display area.

12. A program for an electronic apparatus, the apparatus comprising:
a first display module configured to display a first plurality of icons having approximately the same size within a display screen, the first plurality of icons arranged approximately in a one-dimensional, the first plurality of icons not overlapping one another; and
a second display module configured to display a second plurality of icons continuously with the first plurality of icons in the one-dimensional direction within the display screen, the icons of the second plurality of icons closer to the first plurality of icons being larger than the icons of the second plurality of icons further from the first plurality of icons.
